(19) United States
(12) Patent Application Publication
(10) Pub. No.: US 2010/0138301 A1
(43) Pub. Date: Jun. 3, 2010

(54) METHOD OF CONTROLLING OR ACCESSING DIGITAL CONTENT

(76) Inventors: Richard Affannato, New South Wales (AU); Joseph Figliano, New South Wales (AU); Chris Ibrahim, New South Wales (AU); Paul Ibrahim, New South Wales (AU)

Correspondence Address: MILES & STOCKBRIDGE PC, 1751 PINNACLE DRIVE, SUITE 500, MCLEAN, VA, 22102-3833, US

(21) Appl. No.: 12/438,023

(22) PCT Filed: Jul. 4, 2007
(86) PCT No.: PCT/AU2007/000925

§ 371 Date: Dec. 7, 2009

Related U.S. Application Data
(60) Provisional application No. 60/839,139, filed on Aug. 22, 2006.

(30) Foreign Application Priority Data
Jul. 4, 2006 (AU) 2006903593

(51) Int. Cl. G06F 15/16; G06Q 30/00

(52) U.S. Cl. 705/14.58; 709/231; 705/14.73; 705/14.69

(57) ABSTRACT

A method of controlling digital content (10) is disclosed. The method comprises the steps of providing a digital file (14) including a network address (22), and enabling play of media content within the digital file (14) by connecting to the network address (22).

### FIELD OF THE INVENTION

The present invention relates broadly to a method of controlling or accessing digital content.

### BACKGROUND OF THE INVENTION

The pirating of films costs the industry vast amounts of money. It is estimated that in 2005 US film studios lost $6.1 billion from the pirating of films. Of this loss, $2.4 billion was from illegal internet downloads. The rapid growth of internet piracy can in part be attributed to the development of peer-to-peer networks, such as Bit Torrent™, which allow downloading of large video files quickly and cheaply.

The current business model for the marketing of a film is to first release the film for cinema distribution, then releasing the film for DVD distribution 4 months after the cinema release, and then releasing the film for Pay TV 12 months after the cinema release, and finally releasing the film for free-to-air broadcast 24 months after the cinema release. Most film piracy occurs in the period after cinema release and before DVD distribution.

Furthermore, consumers who obtain pirated films can view the movie without watching advertising that would usually be shown before, after, or during screening. This results in further losses.

### SUMMARY OF THE INVENTION

According to the present invention there is provided a method of controlling digital content, the method comprising the steps of:
providing a digital file including a network address; and
enabling play of media content within the digital file by connecting to the network address.

Preferably the step of providing a digital file includes the step of providing a network address for a network accessible resource in the form of an advertisement.

Preferably the method of controlling digital content further comprises the step of receiving playback information over the network. More preferably the method of controlling digital content further comprises the step of receiving credit; the amount of credit depending on the playback information received over the network.

Preferably the step of providing the digital file includes the step of providing a digital file over the internet. More preferably the step of providing the digital file over the interne includes the step of providing the file via a peer-to-peer network or streaming across the web.

Preferably the step of providing a network address for the network accessible advertisement is after a step of selling network accessible advertising space.

Preferably the step of providing a network address for a network accessible advertisement includes the step of customising the advertisement to an advertisement viewer's location. More preferably the step of providing a′network address for a network accessible advertisement includes the step of customising the advertisement to the advertisement viewer's local time or user preferences.

According to another aspect of the invention there is provided a method of accessing digital content, the method comprising the step of:
a consumer receiving a digital file including a network address; and
enabling play of media content within the digital file by connecting to the network address.

Preferably the step of the consumer receiving the digital file includes the step of the consumer receiving a network address for a network accessible resource in the form of an advertisement.

Preferably the step of the consumer receiving a network address for the network accessible advertisement includes the step of the consumer sending playback information over the network.

Preferably the step of the consumer receiving the digital file includes the step of the consumer receiving a digital file over the internet. More preferably the step of the consumer receiving the digital file over the internet includes the step of the consumer receiving the file via a peer-to-peer network or streaming across the web.

Preferably the step of the consumer receiving a network address for a network accessible advertisement includes the step of the consumer receiving a network address for an advertisement customised to the consumer's location. More preferably the step of the consumer receiving a network address for a network accessible advertisement includes the step of the consumer receiving a network address for an advertisement customised to the consumer's local time or user preferences.

### BRIEF DESCRIPTION OF THE FIGURES

In order to achieve a better understanding of the nature of the present invention a preferred embodiment of a method of controlling or accessing digital content will now be described, by way of example only, with reference to the accompanying drawings in which:

FIG. 1 shows a preferred embodiment of a method of controlling or accessing digital content;

FIG. 2 depicts another embodiment of a method of controlling or accessing digital content;

FIGS. 3 through to 6 show screen shots of digital content with embedded advertisements;

FIG. 7 is a diagram of the consumers end of a network of one embodiment of the invention;

FIG. 8 shows the controlling party charging fees for the embodiment of the method of FIG. 1;

FIG. 9 is a diagram of a PPPOP network of one embodiment of the invention;

FIG. 10 is a diagram of a core advertising network of one embodiment of the invention;

FIG. 11 shows the inputs and outputs of software that builds an executable file used in the preferred embodiment of the method of FIG. 1;

FIG. 12 summarises the method from the perspective of various involved parties;

FIG. 13 is a diagram of a network of a content owner of one embodiment of the invention; and

FIG. 14 is another embodiment of the invention.

### DETAILED DESCRIPTION OF THE PREFERRED EMBODIMENT

In order that the nature of the present invention may be more clearly understood, a preferred form thereof will now be described with reference to the following non-limiting examples.

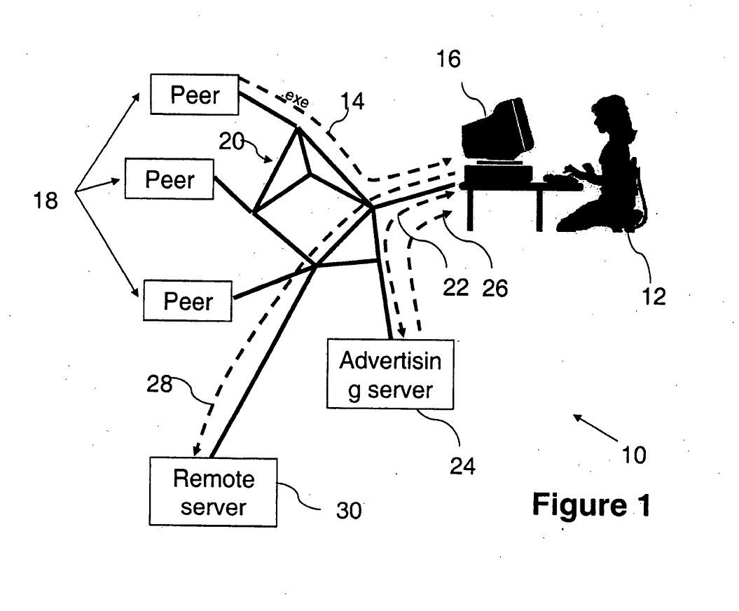

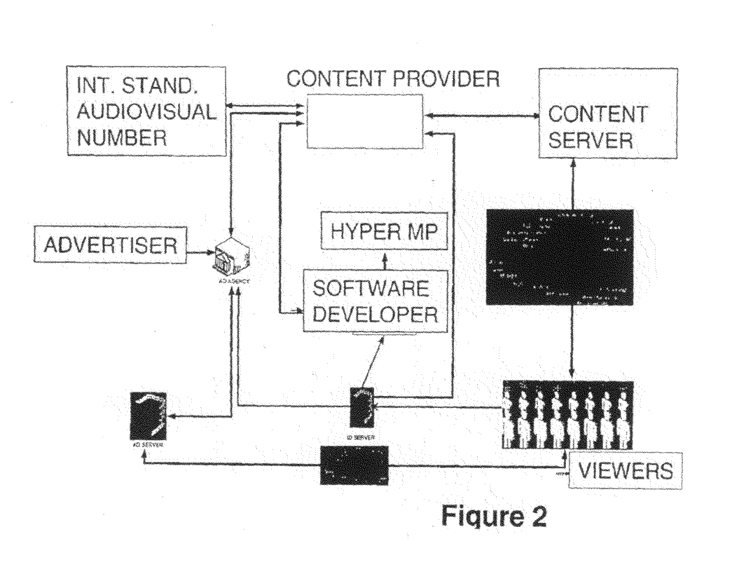

In one embodiment of the invention, generally shown as 10 in FIG. 1, a consumer 12 can download free of charge an executable file 14 to a personal computer 16 using a peer-to-peer network 18, such as Bit Torrent™, over the internet 20. The file 14 contains viewable media content and one or more links 22 or network addresses for network accessible resources on one or more remote servers such as 24 and 30. The media content can be played, at least in part, after the executable file 14 accesses or connects to the link 22 to the network accessible resource. In this embodiment, one network accessible resource is an advertisement 26. This ensures that the consumer 12 views the media content only if they view the advertisement 26. In another embodiment the file is streamed to the personal computer rather than downloaded. The media content will not play unless the link 22 to the advertisement 26 functions. There should be an interne connection to the personal computer 16 for the media content to play. This helps ensure that the consumer 12 will view the advertisement 26 if they view, the media content contained in the executable file 14. FIG. 2 shows another embodiment of the invention similar to the embodiment of FIG. 1.

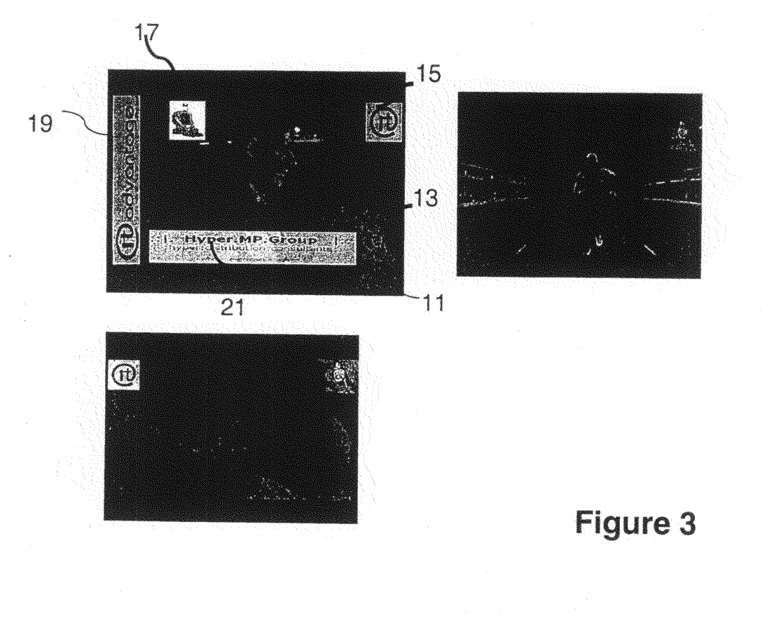

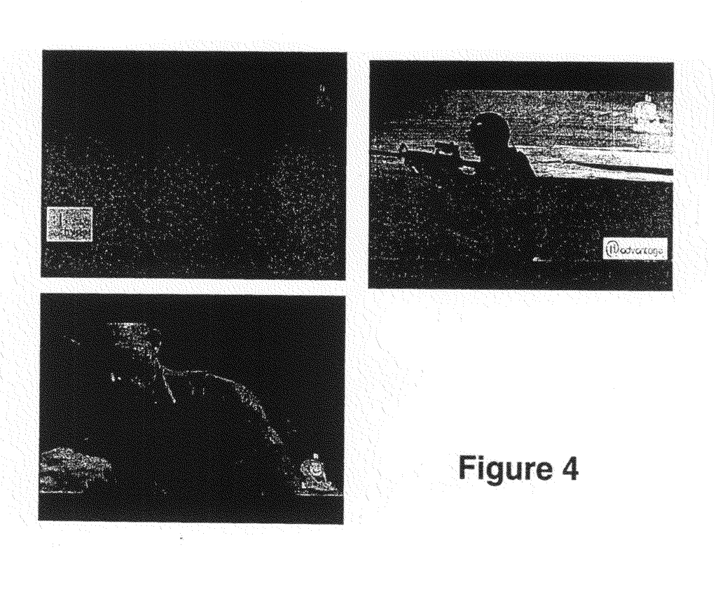

FIGS. 3 through 6 show 11 different screen shots of media, in this case a movie, with embedded advertisements. The advertisements are transferred from the advertisement server 24 by accessing links such as 22. The screen shot 11 of FIG. 3 has multiple advertisements including a vertical banner 19, a horizontal banner 21, an opaque logo 17, and a transparent logo 15. Advertisements such as these fade in and out during play. These advertisements may be either still or animated. The screen shot 11 also includes a ‘bug’ 13, which is a transparent logo that is visible throughout the entire play. The bug 13 may change position during play, which increases the viewer impact.

The left screen shot 23 of FIG. 6 includes a banner advertisement 25 which names the song that is currently being played as part of the movie. In some embodiments, the consumer 12 can click on this banner to be taken to a web site from which the song can be purchased. The right screen shot 35 includes a banner 70 that names the IP address of the computer that downloaded the executable 14. This banner 70 may change its position during play. This acts as a deterrent to people pirating the movie because the IP address is distributed with pirated copies.

In this embodiment the supported video formats include AVI (any codec), MPEG, MOV, FLV, SWF, DVD, streaming. The supported advertising formats include Animated GIF, GIF, Flash SWF and FLV, AVI (any codec), MPEG, MOV, JPG, PNG, BMP.

In this embodiment the advertising types used include pre-roll, post-roll, in-roll, dynamic overlay, picture in picture, single or dual overlay, real-time and placement, and interactive advertising. Different types of advertisement servers are supported including a proprietary server of the applicant.

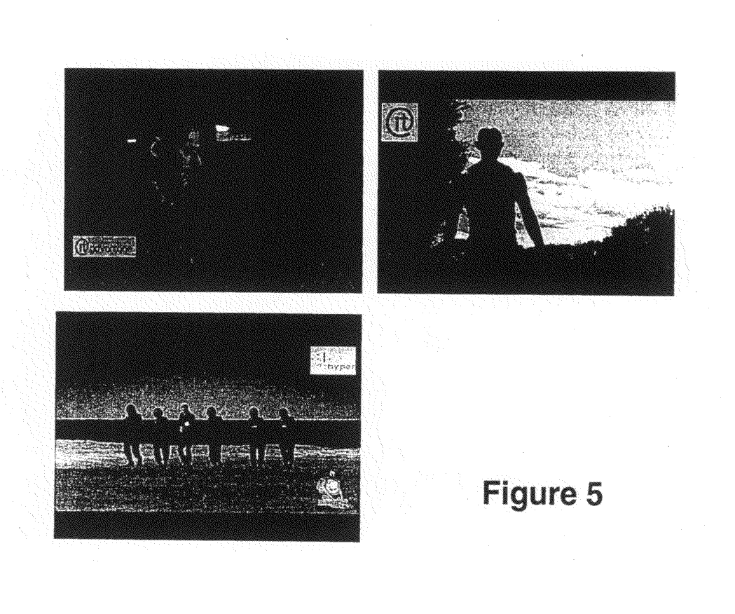

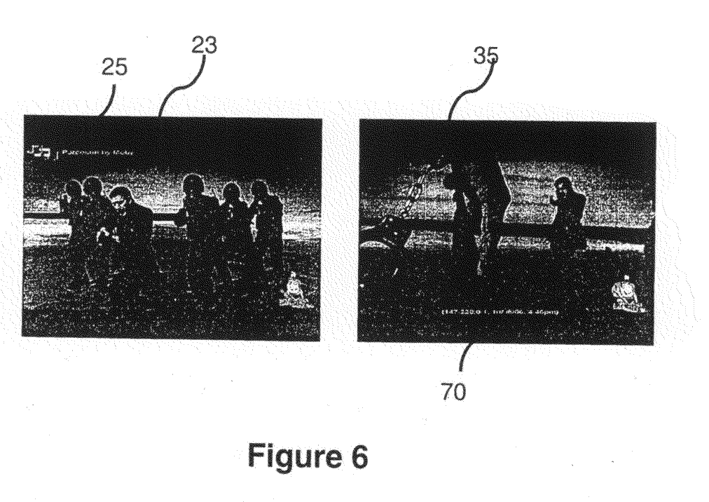

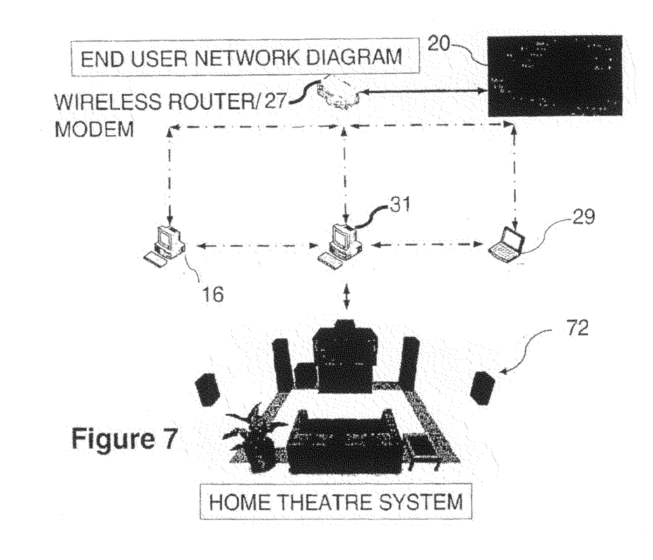

FIG. 7 is a diagram of the network terminating, in this example, in the consumer's 12 lounge room 72. A wireless router/modem 27 is connected to the internet 20. The consumer 12 can access the internet 20 by an electronic device such as the personal computer 16 or a home laptop 29 connected to the wireless router/modem 27.

As the media content is played, the executable file 14 sends playback information in the form of a beacon 28 that registers the play point of the content. The beacon 28 includes the Content Identification Register of the media to identify it. This playback information is sent over the internet 20 to a network accessible resource on a remote server 30, and used to calculate a fee for the service. For example, based on US$2.00 for an entire play:
when 0-25% of the executable file is played the controlling party charges US 50 cents;
when 25-50% is played the controlling party charges US 100 cents;
when 50-75% is played the controlling party charges US 150 cents; and
when 75-100% is played the controlling party charges US 200 cents.

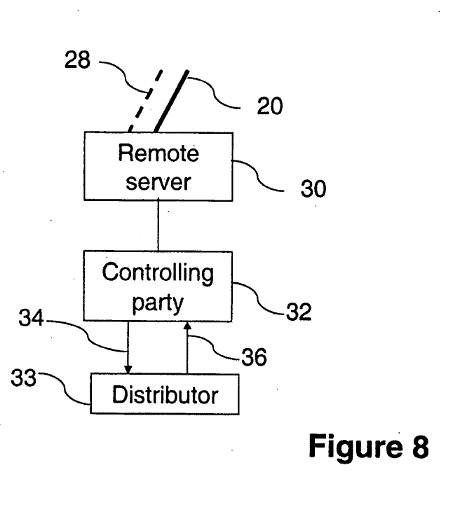

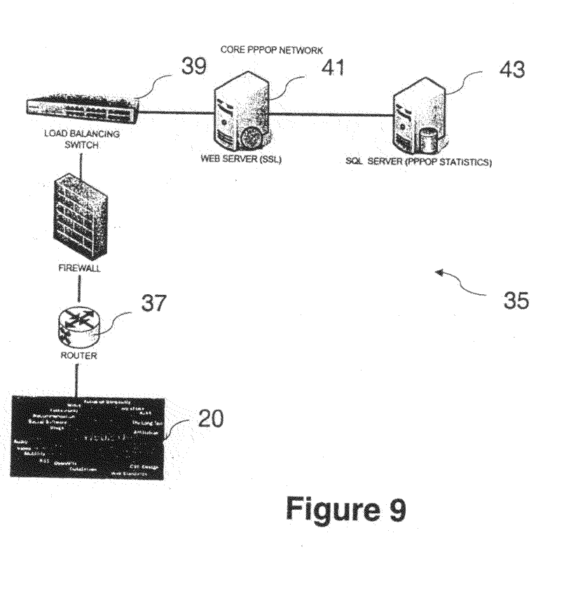

As shown in FIG. 8, the controlling party 32 charges its fees 34 to the distributor of the media content, and thus receives credit 36 depending on the playback information 28 received by the remote server 30. As shown in FIG. 9 this is achieved using a pay per portion of play server 43 (PPPOP), which is part of the core PPPOP network generally indicated at 35. The Web 2.0 sphere 20 represents where the executable 14 will reside inside the internet 20, namely on personal computers such as 16. As content is played from the Web 2.0 sphere 20, the executable 14 periodically informs the PPPOP network 35 of the portion of the content that has been played. The executable 14 broadcasts a Content Identification Register and registers the portion of play and IP address of the consumer 12 with the PPPOP server 43.

The PPPOP server 43 collates Content Identification Register and portion data, allowing the PPPOP server 43 to calculate the fees chargeable. In one embodiment the PPPOP server 43 reports daily and invoices weekly.

The request is made through to the router 37, passing over to the load balancing switch 39. This request is made over an SSL connection (Secure Socket Layer or TCP port 443). The load balancing switch 39 passes this request to a web server 41. The web server 41 processes the request in ASP or XML to drive the data from a SQL database on the SQL Advertising Server 43.

The table structure within the SQL Database will be capable of identifying:
(a) uniquely the content by the Content Identification Register;
(b) the computer on the internet;
(c) the IP address the content is played from;
(d) the date, time, locale, duration of content playback;
(e) the number of adverts streamed;
(f) which adverts have been streamed;
(g) user and password; and
(h) user preferences including advertisement frequency and advertising category.

The advertisement 26 can be changed to suit the consumer's 12 geographical location and local time. Because the computer 16 is connected to the internet 20, the computer 16 has an associated IP address. Sometimes, a reverse DNS can find the host's name which may include the geographical location, or the host may make use of the standard RFC 1876 which is an extension of the DNS specifically including geographical information. Once the geographical location of the host has been determined, a suitable advertisement is placed at the end of the link 22 included in the executable file 14. For example, if the geographical location is Sydney, Australia and the local time is 7.30 am then a suitable advertisement would be for McDonald's™ breakfast products. Advertising shown can also be based on user preferences.

The network accessible advertising space at the end of the link 22 is sold before providing a link 22 to it. The advertising space, in this embodiment, is auctioned to advertisers. The cost of the advertising will thus increase with the popularity of the media content.

In another embodiment the advertising is dynamic and strategically placed within the media content.

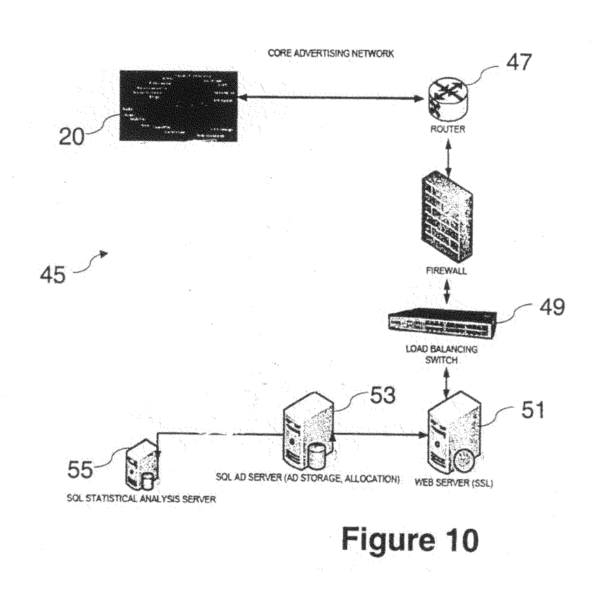

The advertisements are provided by the core advertising network, generally indicated as 45 in FIG. 10. The Web 2.0 sphere, or internet 20, represents where the executable 14 will reside, namely on personal computers such as 16. As content is played from the Web 2.0 sphere, the executable 14 will periodically request from the advertising network 45 a logo or animated graphic to place over the top of the content being played. Supported image formats include: GIF; BMP; and JPEG. The graphic or logo will fade in (for example, over 2.5 seconds), remain steady on the screen (for example, for 25 seconds) then fade out over a period (for example, over 2.5 seconds). A good advertisement length is 30 seconds. This process can occur once every 3 minutes during the content presentation. This process may occur at a frequency other than 3 minutes depending on user preferences. The request is made through to the router 47, passing over to the load balancing switch 49. This request is made over an SSL connection (Secure Socket Layer on TCP port 443). The load balancing switch 49 will pass this request to a web server 51. The web server 51 processes the request in ASP or XML to drive the data from a SQL database on the SQL Advertising Server 53. The table structure within the SQL Database will be capable of:
(a) uniquely identifying by the content through its unique Content Identification Register number;
(b) identifying the computer on the internet;
(c) using the date/time/locale information to provide relevant advertising material based on this criteria;
(d) storing of graphical advertising within the advertising allocation matrix.

A SQL Statistical Analysis Server 55 will be responsible for data collection regarding:
(a) the IP address the content is played from;
(b) the date, time, locale, duration of content playback;
(c) the number of adverts streamed;
(d) which adverts have been streamed;
(e) username and password; and
(f) user preferences including advertisement frequency and advertising category.

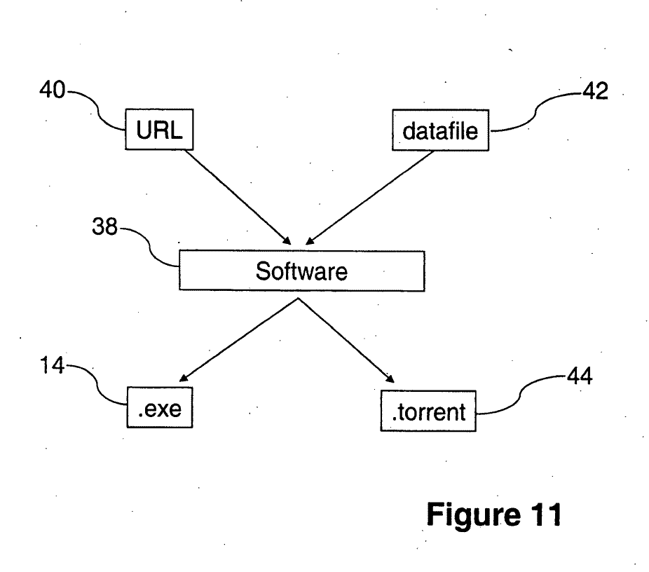

As shown in FIG. 11, the executable file 14 is the output of a software based application 38, the application's input are the URL's 40 of advertising links such as 22 and a data file 42 containing the media content. The data file 42 originates from the content producer, who has obtained an International Standard Audiovisual Number (as described at www.isan.org) which is included in the executable. The date file is encrypted using a codec such as AVI (any codec), MPEG, MOV, FLV, SWF, DVD, or streaming. The software 38 also builds a torrent file 44 to allow the executable 14 to be accessed by the Bit Torrent™ System. In some embodiments, however, the executable file 14 can also be burnt/copies onto removable media, such as DVD or a Portable Hard Disk, for distribution. A standard DVD player will not be able to play the executable file 14, which is undesirable in any case because this may allow the consumer 12 to avoid the viewing of linked advertisements such as 26. The executable file 14 allows the media content to be played, paused, stopped and resumed only. The creation of executable files is generated by the content distributor 33.

It will be appreciated that at least the preferred embodiment allows the originating source of the media content to be verified before it is viewed by the consumer. This can be used to combat piracy of the media content. To help further curb piracy, the viewer's IP address, date and time of viewing can also be embedded into the movie.

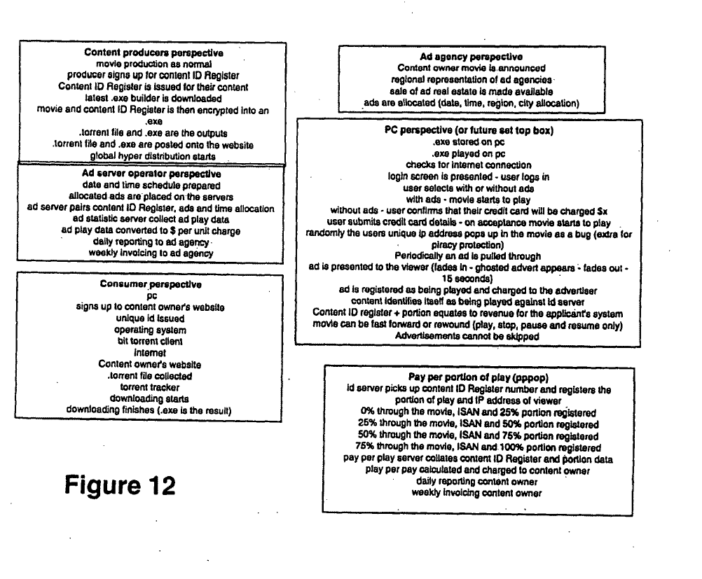

FIG. 12 summarises the method from the perspective of the content producers, the ad agency, the ad server operator, the consumer, the personal computer and also the pay per portion of play (PPPOP).

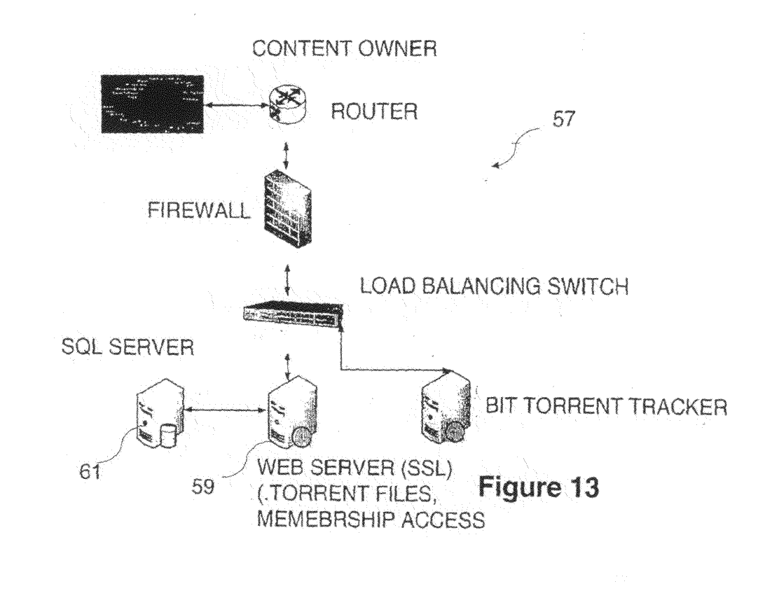

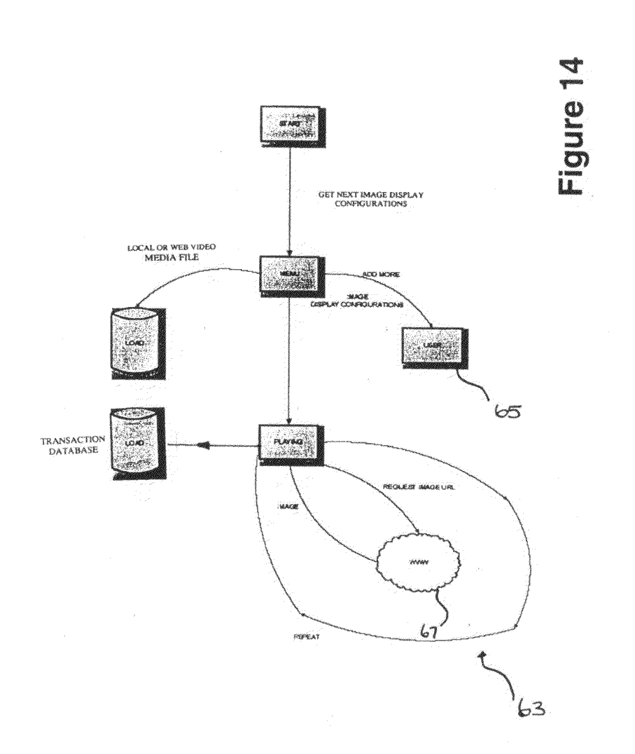

In some embodiments, the executable files are only available to members, in a system of a content owner. The network diagram for such a system is shown in FIG. 13 and generally indicated as 57. The web server 59 will present marketing material about up and coming feature films, and requests for members to sign in to collect their torrent file. All transactions occur over a SSL connection. A SQL Database on a SQL server 61 will be structured to maintain: username; password; persons name; email address; country; and other statistics about the user. The other functions for serving the content is similar to or the same as for peer-to-peer networks such as Bit Torrent™.

In one embodiment, depicted in FIG. 6 and generally indicated as 63, the consumer 65 can view common video media with predefined images transferred from the World Wide Web 67 and displayed at regular time intervals. When image display is required, each image is transferred via the Hypertext Transfer Protocol and displayed by behaviour according to the image's display configuration. Once each image from the configurations list has been displayed, then the image display cycle will start from the first image of the image display configuration list. The image display cycle will continue for the duration of the video media. The operation of this embodiment is as follows:
1. programme starts with initial image configuration;
2. user has option to create further image configurations with the image configuration dialogue;
3. user opens video media dialogue and selects a video media file to load;
4. the video media starts playing with the option to pause, stop and restart the viewing of the media;
5. commence image display cycle;
6. display first image;
7. display remaining images; and
8. return to first image after last image has been displayed.

Media player features such as menu items, buttons, colours, look and feel are all customisable.

Each image display configuration is defined by the following display properties:
Source Image URL, eg http://www.sourcewebsite1.com/source_image.gif;
Image display size (pixels), eg width=150, height=100 pixels;
Image display position (pixels) eg top=50, left=70 pixels;
Image display duration (seconds), eg 300 seconds; and
Image display transparency (%), eg 50%.

In a preferred embodiment the target platform is MS Windows 2000 or XP or Windows Vista. This embodiment may use components/libraries including: Net Framework 1.1; 2.0, 3.0; Direct X 9.x, 10.x; or Direct X 9.x, 10.x SDK. The best known development platform is MS Visual Studio, 2003, 2005 using C#.

It will be appreciated by persons skilled in the art that numerous variations and/or modifications may be made to the invention as shown in the specific embodiments without departing from the spirit or scope of the invention as broadly described. For example, the personal computer could be using a Mircosoft™ Windows™ or Linux™ operating systems, or be an Apple™ Mac™ computer, a Microsoft™ Xbox360™, a Sony Playstation or in the future a purpose built set top box. The present embodiments are, therefore, to be considered in all respects as illustrative and not restrictive.

1. A method of controlling digital content, the method comprising the steps of:
providing a digital file including a network address; and
enabling play of media content within the digital file by connecting to the network address.

2. A method of controlling digital content as defined in claim 1 wherein the step of providing a digital file includes the step of providing a network address for a network accessible resource in the form of an advertisement.

3. A method of controlling digital content as defined in either of claim 1 or 2 further comprising the step of receiving playback information over the network.

4. A method of controlling digital content as defined in claim 3 further comprising the step of receiving credit, the amount of credit depending on the playback information received over the network.

5. A method of controlling digital content as defined in any one of the preceding claims wherein the step of providing the digital file includes the step of providing a digital file over the internet.

6. A method of controlling digital content as defined in claim 5 wherein the step of providing the digital file over the internet includes the step of providing the file via a peer-to-peer network or streaming over the web.

7. A method of controlling digital content as defined in claim 2 wherein the step of providing a network address for the network accessible advertisement is after a step of selling network accessible advertising space.

8. A method of controlling digital content as defined in either of claim 2 or 7 wherein the step of providing a network address for a network accessible advertisement includes the step of customising the advertisement to an advertisement viewer's location.

9. A method of controlling digital content as defined in any one of claims 2,7 or 8 wherein the step of providing a network address for a network accessible advertisement includes the step of customising the advertisement to an advertisement viewer's local time or user preferences.

10. A method of accessing digital content, the method comprising the step of:
a consumer receiving a digital file including a network address; and
enabling play of media content within the digital file by connecting to the network address.

11. A method of controlling digital content as defined in claim 10 wherein the step of the consumer receiving the digital file includes the step of the consumer receiving a network address for a network accessible resource in the form of an advertisement.

12. A method of controlling digital content as defined in claim 11 wherein the step of the consumer receiving a network'address for the network accessible advertisement includes the step of the consumer sending playback information over the network.

13. A method of controlling digital content as defined in any one of claims 10 to 12 wherein the step of the consumer receiving the digital file includes the step of the consumer receiving a digital file over the internet.

14. A method of controlling digital content as defined in claim 13 wherein the step of the consumer receiving the digital file over the internet includes the step of the consumer receiving the file via a peer-to-peer network or streaming over the web.

15. A method of controlling digital content as defined in either of claim 11 or 12 wherein the step of the consumer receiving a network address for a network accessible advertisement includes the step of the consumer receiving a network address for an advertisement customised to the consumer's location.

16. A method of controlling digital content as defined in any one of claims 11, 12 or 15 wherein the step of the consumer receiving a network address for a network accessible advertisement includes the step of the consumer receiving a network address for an advertisement customised to the consumer's local time or user preferences.
